(19) United States
(12) Patent Application Publication
(10) Pub. No.: US 2026/0249654 A1
(43) Pub. Date: Aug. 27, 2026

(54) PNEUMATIC TIRE

(71) Applicant: Toyo Tire Corporation, Itami-shi (JP)

(72) Inventor: Taiichi Nishio, Itami-shi (JP)

(73) Assignee: Toyo Tire Corporation, Itami-shi (JP)

(21) Appl. No.: 19/544,221

(22) Filed: Feb. 19, 2026

(30) Foreign Application Priority Data
Feb. 21, 2025 (JP) 2025-026562

(51) Int. Cl. B60C 11/12; B60C 11/03

(52) U.S. Cl. CPC B60C 11/1218; B60C 11/0306; B60C 2011/0341; B60C 2011/1268

(57) ABSTRACT

A tire according to an embodiment includes a sipe provided in a land. The sipe includes a bottom protrusion projecting beyond a groove bottom of the circumferential groove toward a ground-contact surface side, the bottom protrusion includes a first crest, a second crest that is provided on each side in a tire axial direction of the first crest and is located on an inner side in a tire radial direction of the first crest, and an arcuate portion between the first crest and the second crest. The arcuate portion includes a first arcuate portion that is provided continuously from the first crest and bulges toward an outer side in the tire radial direction, and a second arcuate portion that is provided continuously from the first arcuate portion and is recessed toward the inner side in the tire radial direction.

### CROSS-REFERENCE TO RELATED APPLICATIONS

This application claims the benefit of and priority to Japanese Patent Application No. 2025-026562 filed on February 21, 2025, and the content thereof is incorporated herein by reference in its entirety.

### BACKGROUND OF THE INVENTION

### Field of the Invention

The present invention relates to a pneumatic tire.

### Description of Related Art

A pneumatic tire is known which has a plurality of lands defined by circumferential grooves extending in a tire circumferential direction and has sipes that are formed on the lands and are open to the circumferential grooves. In such a pneumatic tire, cracks tend to occur at a location that corresponds to an intersection portion of a circumferential groove and a sipe and to a bottom of a sipe.

An example of a pneumatic tire having such a structure is disclosed in JP2019-214315A. The pneumatic tire disclosed in JP2019-214315A has, in a sipe having the structure described above, a deep-bottom portion with a great depth and a shallow-bottom portion with a shallow depth, and when a tread is worn, only the deep-bottom portion remains as a closed sipe, and wet performance is achieved by employing the closed sipe. The sipe has a discontinuous step between the deep-bottom portion and the shallow-bottom portion (step formed by a plane extending in a direction substantially vertical to the ground-contact surface between the deep-bottom portion and the shallow-bottom portion).

Conventionally, even in a land where the sipe has the deep-bottom portion and the shallow-bottom portion as described above, the occurrence of cracks could not be sufficiently reduced.

### SUMMARY OF THE INVENTION

The invention has been achieved in light of such circumstances, and therefore, an object of the invention is to provide a pneumatic tire in which cracks are less likely to occur at a location that corresponds to an intersection portion of a circumferential groove and a sipe and to a bottom of the sipe.

According to an embodiment, a pneumatic tire includes, on a tread, a circumferential groove extending in a tire circumferential direction, a plurality of lands defined by the circumferential groove, and a sipe provided in one or more of the lands, in which the sipe extends in a tire axial direction, has both ends open to the circumferential groove, and includes a bottom protrusion projecting beyond a groove bottom of the circumferential groove toward a ground-contact surface, the bottom protrusion includes a first crest, a second crest that is provided on each side in the tire axial direction of the first crest and is located on an inner side in a tire radial direction of the first crest, and an arcuate portion provided between the first crest and the second crest, and the arcuate portion includes a first arcuate portion that is provided continuously from the first crest and has a cross-sectional arc shape that bulges toward an outer side in the tire radial direction such that a protrusion height from the groove bottom is gradually reduced as a distance from the first crest increases, and a second arcuate portion that is provided continuously from the first arcuate portion and has a cross-sectional arc shape that is recessed toward the inner side in the tire radial direction such that a protrusion height from the groove bottom is gradually reduced as a distance from the first arcuate portion increases.

In the pneumatic tire according to the embodiment, cracks are less likely to occur at a location that corresponds to an intersection portion of a circumferential groove and a sipe and to a bottom of the sipe.

### BRIEF DESCRIPTION OF THE DRAWINGS

FIG. 1 illustrates a tread pattern of a pneumatic tire according to an embodiment;

FIG. 2 is a cross-sectional view along a sipe extension direction in a quarter land;

FIG. 3 is an enlarged view illustrating the vicinity of an arcuate portion in FIG. 2; and

FIG. 4 is an enlarged view illustrating the vicinity of an arcuate portion according to a modification.

### DESCRIPTION OF EMBODIMENTS

A pneumatic tire of the present embodiment has a general internal structure as a pneumatic tire. Although not illustrated in the drawings, specifically, a bead, which is a portion including a bead core and a bead filler, is provided on each side in the tire axial direction. A carcass ply is laid from one bead to the other bead in the tire axial direction. A belt is disposed on the outer side in the tire radial direction of the carcass ply, and a tread rubber is disposed on the outer side in the tire radial direction of the belt. Further, a sidewall rubber is disposed on each side in the tire axial direction of the carcass ply. In addition to the above, a plurality of rubber members is disposed to configure the pneumatic tire.

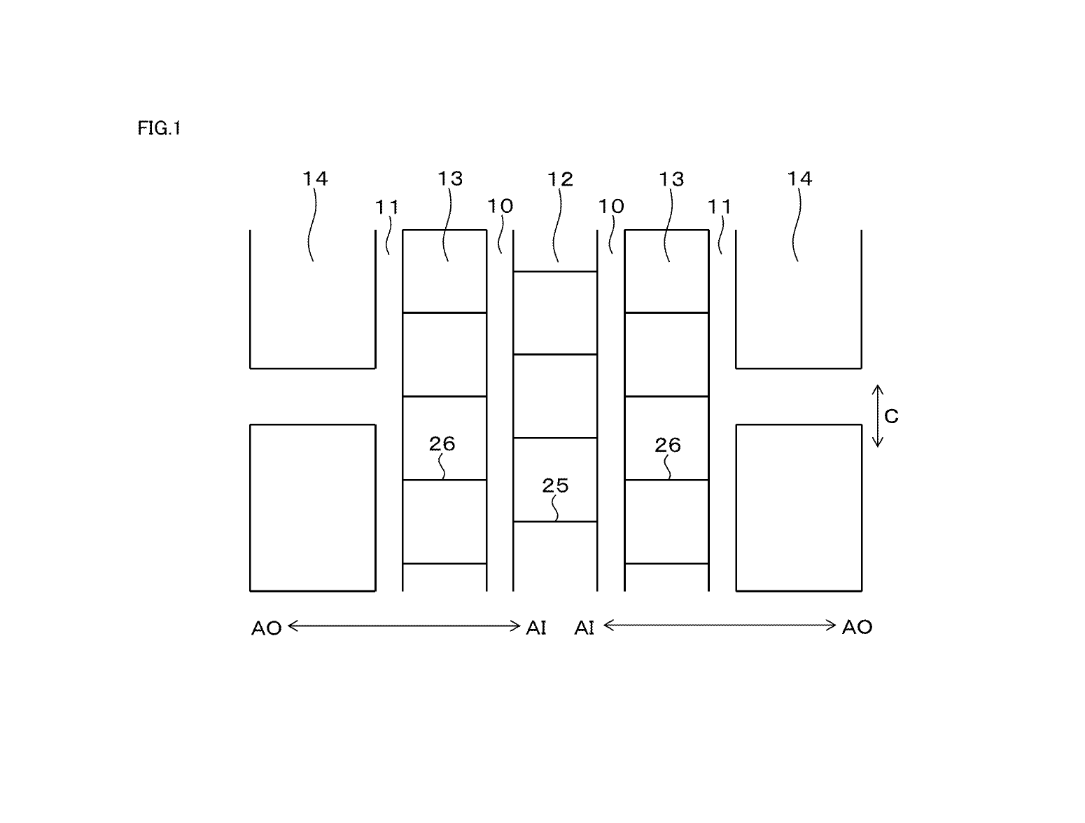

A tread pattern illustrated in FIG. 1 is formed on the tread rubber. In the drawings, the inner side in the tire axial direction is denoted by “AI” and the outer side in the tire axial direction is denoted by “AO”. In the tire axial direction, the inner side refers to the tire equatorial side, and the outer side refers to the direction away from the tire equator. Further, in the drawings, the tire circumferential direction is denoted by “C”, the inner side in the tire radial direction is denoted by “RI”, and the outer side in the tire radial direction is denoted by “RO”. In the tire radial direction, the inner side refers to the tire rotational axis side, and the outer side refers to the side away from the tire rotational axis.

In the tread pattern, circumferential grooves extending in the tire circumferential direction include two center main grooves 10 on the inner side in the tire axial direction and two shoulder main grooves 11 on the outer side in the tire axial direction. Lands formed to be spaced from each other by the circumferential grooves (main grooves) include a center land 12 between the two center main grooves 10, a quarter land 13 between the center main groove 10 and the shoulder main groove 11, and a shoulder land 14 positioned on the outer side in the tire axial direction of the shoulder main groove 11. The quarter land 13 and the shoulder land 14 are disposed on each side in the tire axial direction.

The center land 12 and the quarter lands 13 include a plurality of sipes 25 and 26, respectively. The sipe is a groove having a width of 0.3 mm or more and 1.2 mm or less. In each of the center land 12 and the quarter lands 13, an interval between two sipes 25 or 26 adjacent to each other in the tire circumferential direction is 200% or more and 300% or less of the depth of the sipes 25 or 26 (depth from a ground-contact surface 28 to a first crest 31 described later). Incidentally, in order to prevent uneven wear of the shoulder lands 14, a sipe that is open to the circumferential groove is not provided in the shoulder lands 14.

Hereinafter, one quarter land 13 will be described by way of example.

The quarter land 13 includes the plurality of sipes 26 parallel to one another. The sipes 26 generally extend in the tire axial direction. As illustrated in FIG. 1, the sipes 26 may extend in a direction making an angle of 90º with respect to the tire circumferential direction (namely, in the tire axial direction), or, alternatively, may be inclined to the tire circumferential direction and the tire axial direction. The inclination angle of the sipes 26 with respect to the tire circumferential direction for a case where the sipes 26 are inclined to the tire circumferential direction and the tire axial direction is, for example, 65º or more and less than 90º. Both ends of each sipe 26 in the extension direction are open to the circumferential grooves (main grooves) 10 and 11 provided on both sides in the tire axial direction of the quarter land 13.

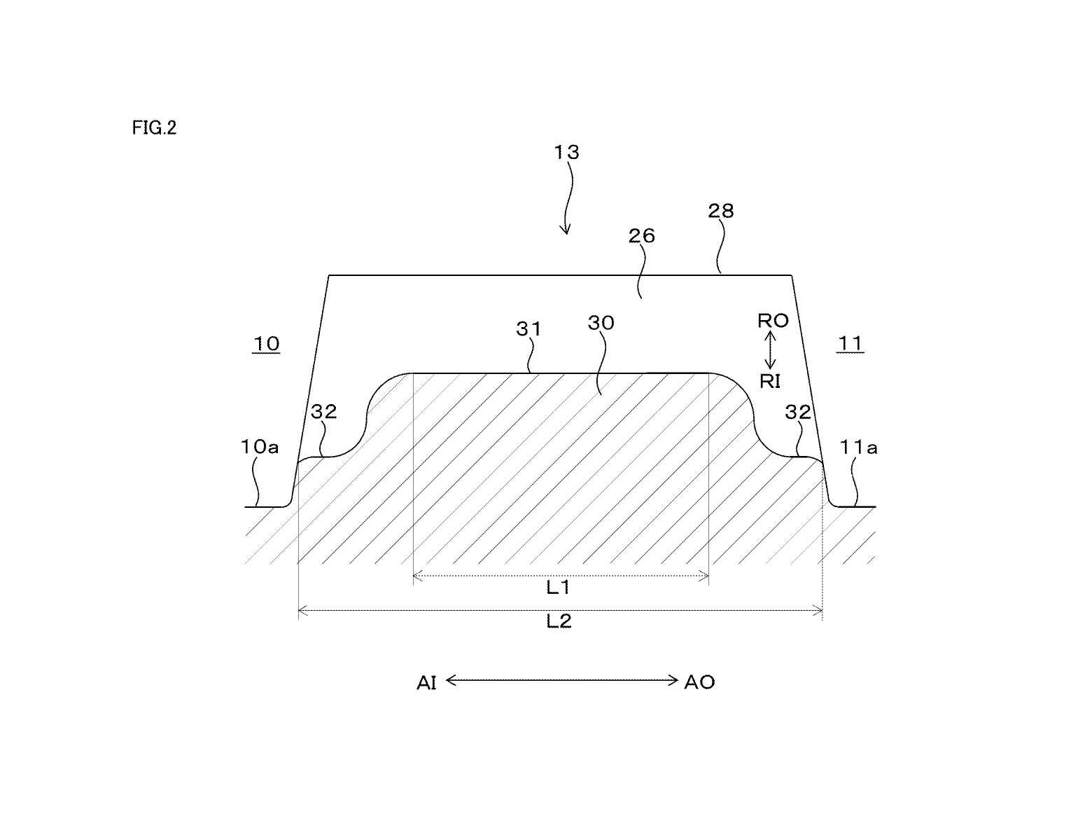

As illustrated in FIG. 2, the sipe 26 is shallower than the circumferential grooves (main grooves) 10 and 11. It can thus be said that a bottom protrusion 30 which projects beyond groove bottoms 10a and 11a of the circumferential grooves (main grooves) 10 and 11 toward the outer side in the tire radial direction (the ground-contact surface 28 side of the quarter land 13) is formed under the sipe 26 in the quarter land 13. Both ends in the tire axial direction of the bottom protrusion 30 correspond to both ends in the tire axial direction of the quarter land 13.

The bottom protrusion 30 includes the first crest 31 at the center in the tire axial direction and a second crest 32 on each side in the tire axial direction of the first crest 31. The second crests 32 are located on the inner side in the tire radial direction of the first crest 31. Thus, the sipe 26 is shallow at the center in the tire axial direction, and is deep on both sides in the tire axial direction. In the bottom protrusion 30, the first crest 31 is the highest part protruding outward in the tire radial direction.

Due to the shape formed by the first crest 31 and the second crests 32, the both sides in the tire axial direction of the quarter land 13 are more easily movable than the central part in the tire axial direction thereof, and distortion is more likely to be absorbed in the easily movable portion. Further, due to the shape formed by the first crest 31 and the second crests 32, the rigidity of the quarter land 13 gradually changes from the groove bottoms 10a and 11a of the circumferential grooves (main grooves) 10 and 11 to the ground-contact surface 28 of the quarter land 13, and there is no region exhibiting a substantial difference in rigidity. Thus, cracks are less likely to occur in a part that corresponds to an intersection portion of the circumferential grooves (main grooves) 10 and 11 and the sipe 26 and to the bottom of the sipe 26.

A length L1 in the tire axial direction of the first crest 31 is equal to or greater than half a length L2 in the tire axial direction of the bottom of the sipe 26. Further, the first crest 31 and the second crests 32 are parallel to the groove bottoms 10a and 11a of the circumferential grooves (main grooves) 10 and 11 and the ground-contact surface 28 of the quarter land 13.

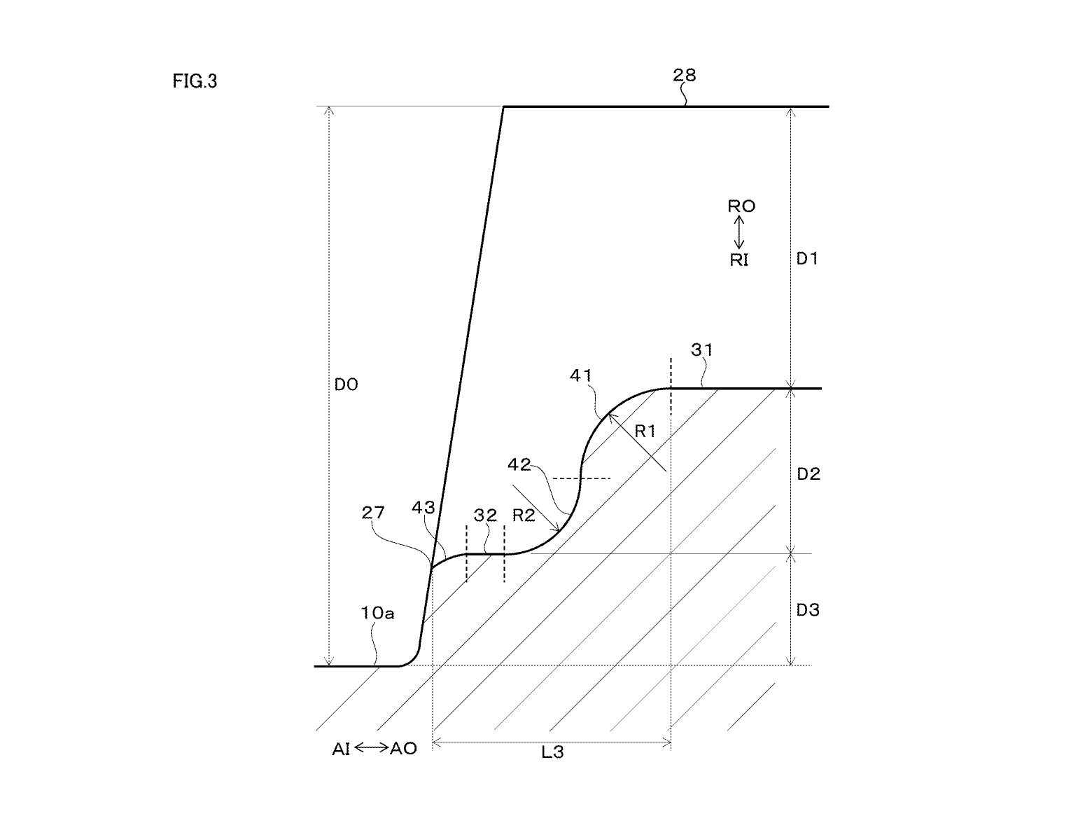

In each side in the tire axial direction of the bottom protrusion 30, an arcuate portion is provided between the first crest 31 and the second crest 32. As illustrated in FIG. 3, the arcuate portion includes two arcuate portions of a first arcuate portion 41 and a second arcuate portion 42 that are continuously formed. The first arcuate portion 41 is provided continuously from the first crest 31 and has a cross-sectional arc shape that bulges toward the outer side in the tire radial direction such that the protrusion height from the groove bottoms 10a and 11a is gradually reduced as the distance from the first crest 31 increases. Further, the second arcuate portion 42 is provided continuously from the first arcuate portion 41 and has a cross-sectional arc shape that is recessed toward the inner side in the tire radial direction such that the protrusion height from the groove bottoms 10a and 11a is gradually reduced as the distance from the first arcuate portion 41 increases.

Broken lines in FIG. 3 indicate a boundary (joint portion) between the first crest 31 and the first arcuate portion 41, a boundary (joint portion) between the first arcuate portion 41 and the second arcuate portion 42, a boundary (joint portion) between the second arcuate portion 42 and the second crest 32, and a boundary (joint portion) between the second crest 32 and an outer arcuate portion 43 described later.

When the pneumatic tire rolls on a road surface, stress is generated in a direction that opens the sipes 26. At this time, the stress in the direction that opens the sipes 26 from the first crest 31 to the second crest 32 gradually changes because the first arcuate portion 41 and the second arcuate portion 42 are continuous in the arcuate portion between the first crest 31 and the second crest 32 at the bottom of the sipe 26 as described above. Thus, stress concentration tends not to occur in the arcuate portions and the vicinity thereof, resulting in reduced crack occurrence. Further, since the first arcuate portion 41 and the second arcuate portion 42 are continuous, the radius of curvature of each of the first arcuate portion 41 and the second arcuate portion 42 can be set as large as possible in a small region between the first crest 31 and the second crest 32, which prevents stress from being concentrated.

A length L3, in a direction parallel to the first crest 31 and the second crest 32, from the boundary between the first crest 31 and the first arcuate portion 41 to an end 27 of the bottom of the sipe 26 in the tire axial direction is preferably 3 mm or more and 6 mm or less. Since the length L3 is 3 mm or more, distortion is easily absorbed around the end of the sipe 26 in the tire axial direction. Further, since the length L3 is 6 mm or less, rigidity around the end of the sipe 26 in the tire axial direction is prevented from decreasing excessively, and the difference in rigidity between the part from the first crest 31 to the second crest 32 and a part on the inner side in the tire radial direction of the second crest 32 is prevented from becoming excessively large.

The outer arcuate portion 43 is formed between the second crest 32 and the end 27 of the bottom of the sipe 26 in the tire axial direction. The outer arcuate portion 43 has a cross-sectional arc shape that bulges toward the outer side in the tire radial direction such that the protrusion height from the groove bottoms 10a and 11a is gradually reduced as the distance to the circumferential grooves (main grooves) 10 and 11 decreases. Since the outer arcuate portion 43 is formed as described above, cracks are even less likely to occur in a part that corresponds to the intersection portion of the circumferential grooves (main grooves) 10 and 11 and the sipe 26 and to the bottom of the sipe 26.

Each arcuate portion is a portion that appears as an arc in the cross-sectional view along the extension direction of the sipe 26; however, it is, in fact, an elongated curved surface having the same width as that of the sipe 26. Further, each crest is a portion that appears as a direct line in the cross-sectional view along the extension direction of the sipe 26; however, it is, in fact, an elongated plane having the same width as that of the sipe 26. The first crest 31, the second crest 32, the first arcuate portion 41, the second arcuate portion 42, and the outer arcuate portion 43 correspond to the bottom of the sipe 26.

A radius of curvature R1 of the first arcuate portion 41 is greater than a radius of curvature R2 of the second arcuate portion 42. Further, the ratio of the radius of curvature R1 of the first arcuate portion 41 to the radius of curvature R2 of the second arcuate portion 42 is 3.0 or less. To summarize, 3.0 > R1/R2 > 1.0 is established. A more preferable range is 2.00 > R1/R2 > 1.25. Further, the radius of curvature of the outer arcuate portion 43 is preferably greater than the radius of curvature R2 of the second arcuate portion 42.

As described above, since the length L1 in the tire axial direction of the first crest 31 is equal to or greater than half the length L2 in the tire axial direction of the bottom of the sipe 26, and when the pneumatic tire rolls on the road surface, a part from the ground-contact surface 28 to the first crest 31 of the quarter land 13 moves more than a part from the first crest 31 to the second crest 32 of the quarter land 13. Further, in the tire radial direction, the difference in rigidity between the part from the ground-contact surface 28 to the first crest 31 and the part from the first crest 31 to the second crest 32 is larger than the difference in rigidity between the part from the first crest 31 to the second crest 32 and the part on the inner side in the tire radial direction of the second crest 32. Therefore, when comparison is made between the vicinity of the second crest 32 and the vicinity of the first crest 31, it appears that more stress tends to concentrate in the vicinity of the first crest 31 (particularly, the vicinity of both ends in the tire axial direction of the first crest 31) than in the vicinity of the second crest 32. However, since the radius of curvature R1 of the first arcuate portion 41 close to the first crest 31 is greater than the radius of curvature R2 of the second arcuate portion 42 close to the second crest 32, stress concentration tends not to occur in the vicinity of the both ends in the tire axial direction of the first crest 31, resulting in reduced crack occurrence.

Further, the ratio of the radius of curvature R1 of the first arcuate portion 41 to the radius of curvature R2 of the second arcuate portion 42 is 3.0 or less. As a result, the size of the radius of curvature R2 of the second arcuate portion 42 is ensured, the difference in rigidity between the part from the first crest 31 to the second crest 32 and the part on the inner side in the tire radial direction of the second crest 32 is prevented from becoming excessively large, and cracks starting from the vicinity of the second crest 32 are less likely to occur.

The characteristics of the first crest 31, the second crest 32, the first arcuate portion 41, the second arcuate portion 42, and the outer arcuate portion 43 are the same as one another on both sides of the sipe 26 in the extension direction.

A length D1 in the tire radial direction from the ground-contact surface 28 of the quarter land 13 to the first crest 31 of the bottom protrusion 30 is 50% or more and 75% or less of a depth (that is, the length in the tire radial direction from the ground-contact surface 28 of the quarter land 13 to the groove bottoms 10a and 11a of the circumferential grooves (main grooves) 10 and 11) D0 of the circumferential grooves (main grooves) 10 and 11. Further, the ratio of a length D2 in the tire radial direction from the second crest 32 to the first crest 31 to a length D3 in the tire radial direction from the groove bottoms 10a and 11a of the circumferential grooves (main grooves) 10 and 11 to the second crest 32 is 1.0 or more and 2.0 or less.

On the premise that D1 is 50% or more and 75% or less of D0, the length of D2 is ensured sufficiently because the ratio of D2 to D3 is 1.0 or more (that is, D2 is longer than D3), and the length of D3 is ensured sufficiently because the ratio of D2 to D3 is 2.0 or less. Thus, the rigidity can gradually change from the groove bottoms 10a and 11a of the circumferential grooves (main grooves) 10 and 11 to the ground-contact surface 28 of the quarter land 13.

All the sipes 26 of two quarter lands 13 have the characteristics of the sipes 26 described above. Further, all the sipes 25 of the center land 12 have the same characteristics as the sipes 26 of the quarter lands 13.

The pneumatic tire of the embodiment can be used as a heavy-duty tire mounted on trucks, buses, and so on, and also as a tire for light trucks. Regardless of the type of vehicle on which the pneumatic tire is mounted, the pneumatic tire of the embodiment has the configuration described above, and thus, cracks are less likely to occur in the pneumatic tire.

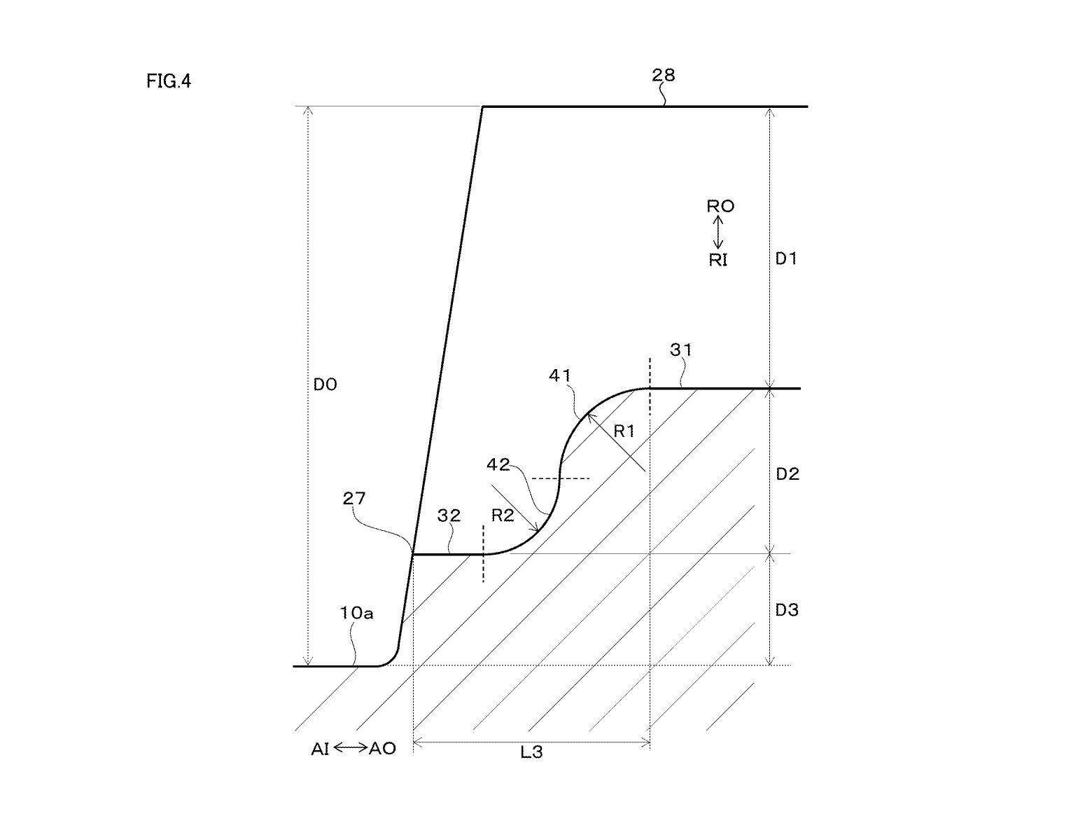

Various modifications can be made to the embodiment described above. For example, a configuration is possible in which the outer arcuate portion 43 is not provided and the second crest 32 extends to the end 27 of the bottom of the sipe 26 in the axial direction as illustrated in FIG. 4.

### Reference Signs List

10: center main groove

10a: groove bottom

11: shoulder main groove

11a: groove bottom

12: center land

13: quarter land

14: shoulder land

25: sipe

26: sipe

27: end in axial direction

28: ground-contact surface

30: bottom protrusion

31: first crest

32: second crest

41: first arcuate portion

42: second arcuate portion

43: outer arcuate portion

What is claimed is:

1. A pneumatic tire comprising, on a tread, a circumferential groove extending in a tire circumferential direction, a plurality of lands defined by the circumferential groove, and a sipe provided in one or more of the lands, wherein
the sipe extends in a tire axial direction, has both ends open to the circumferential groove, and includes a bottom protrusion projecting beyond a groove bottom of the circumferential groove toward a ground-contact surface,
the bottom protrusion includes a first crest, a second crest that is provided on each side in the tire axial direction of the first crest and is located on an inner side in a tire radial direction of the first crest, and an arcuate portion provided between the first crest and the second crest, and
the arcuate portion includes a first arcuate portion that is provided continuously from the first crest and has a cross-sectional arc shape that bulges toward an outer side in the tire radial direction such that a protrusion height from the groove bottom is gradually reduced as a distance from the first crest increases, and a second arcuate portion that is provided continuously from the first arcuate portion and has a cross-sectional arc shape that is recessed toward the inner side in the tire radial direction such that a protrusion height from the groove bottom is gradually reduced as a distance from the first arcuate portion increases.

2. The pneumatic tire according to claim 1, wherein
a length in the tire axial direction of the first crest is equal to or greater than half a length in the tire axial direction of a bottom of the sipe, and
a radius of curvature of the first arcuate portion is greater than a radius of curvature of the second arcuate portion.

3. The pneumatic tire according to claim 2, wherein a ratio of the radius of curvature of the first arcuate portion to the radius of curvature of the second arcuate portion is 3.0 or less.

4. The pneumatic tire according to claim 1, wherein
a length in the tire radial direction from the first crest to the ground-contact surface is 50% or more and 75% or less of a length in the tire radial direction from the groove bottom to the ground-contact surface, and
a ratio of a length in the tire radial direction from the groove bottom to the second crest to a length in the tire radial direction from the second crest to the first crest is 1.0 or more and 2.0 or less.

5. The pneumatic tire according to claim 1, comprising an outer arcuate portion that is provided on a circumferential groove side relative to the second crest, and has a cross-sectional arc shape that bulges toward the outer side in the tire radial direction such that a protrusion height from the groove bottom is gradually reduced as a distance to the circumferential groove decreases.

6. The pneumatic tire according to claim 5, wherein a structure including the second crest, the first arcuate portion, the second arcuate portion, and the outer arcuate portion is a same on both sides in the tire axial direction of the first crest.

7. The pneumatic tire according to claim 1, wherein the first crest and the second crest are parallel to the groove bottom of the circumferential groove and the ground-contact surface of the land.

8. The pneumatic tire according to claim 1, wherein a length in the tire axial direction from a boundary between the first crest and the first arcuate portion to an end in the tire axial direction of the sipe is 3 mm or more and 6 mm or less.

9. The pneumatic tire according to claim 1, wherein
the circumferential groove includes two center main grooves on an inner side in the tire axial direction, and two shoulder main grooves on an outer side in the tire axial direction,
the lands include a center land formed between the two center main grooves, a quarter land formed between the center main groove and the shoulder main groove on each side in the tire axial direction, and a shoulder land formed on the outer side in the tire axial direction of the shoulder main groove on each side in the tire axial direction, and
the sipe is provided only in each of the center land and the quarter land on each side in the tire axial direction.
